(19) United States
(12) Patent Application Publication
(10) Pub. No.: US 2010/0005136 A1
(43) Pub. Date: Jan. 7, 2010

(54) Method and system for follow-me scanning

(76) Inventors: Andrew Rodney Ferlitsch, Camas, WA (US); Joseph Bert Murdock, Camas, WA (US)

Correspondence Address: SHARP LABORATORIES OF AMERICA, INC., 1320 PEARL ST., SUITE 228, BOULDER, CO, 80302, US

(21) Appl. No.: 12/217,546

(22) Filed: Jul. 7, 2008

(51) Int. Cl. G06F 15/16

(52) U.S. Cl. 709/203

(57) ABSTRACT

A method and system for follow-me scanning in a shared resource environment improves image scanning in a shared resource environment in part by decoupling the act of generating a scanned image from the act of identifying a destination for the scanned image. In accordance with the teachings of the invention, a user scans an image on a shared scanner device without identifying a destination for the scanned image. When the user later wants to use the scanned image, the user specifies a destination for the scanned image and the scanned image is sent to the destination. A user can thus without giving any consideration to a destination for a scanned image create the scanned image on an arbitrary scanner device and, at a later time, recover the scanned image using an arbitrary client device. In some embodiments, follow-me scanning is facilitated by a server device that intermediates between scanner devices and client devices and allows the scanned image to be imported directly into workflows and applications running on the client devices.

### BACKGROUND OF THE INVENTION

The present invention relates to image scanning and, more particularly, to image scanning in a shared resource environment, such as a public access (e.g. hotel, airport, convenience store) or multi-user workgroup environment.

There are several known ways to download a scanned image (e.g. scanned document) from a scanner device to a client device. A first approach is to connect the client device directly to the scanner device using a cable, such as a Small Computer Systems Interface (SCSI), parallel port or Universal Serial Bus (USB) connector, and invoke a scan driver on the client device to instruct the scanner device to scan the image and download the scanned image to the client device. A shortcoming of this approach is that a dedicated local physical connection must be made between a particular client device and scanner device, which does not scale to an environment where a scanner device is shared among a large and/or transient user population.

A second approach that is better suited to a shared resource environment is scan-to-email. In scan-to-email, the user inputs an email address into a scanner device or selects a pre-stored email address from an address book on the scanner device and the scanner device scans the image and routes the scanned image to an email server from which the scanned image is later downloaded to a client device. A shortcoming of this approach is that the user must know the email address at the time the image is scanned. Moreover, the user may input or select an erroneous email address and not realize the error until after he or she has returned to his or her client device. Furthermore, the scanned image is subject to email server restrictions (e.g. storage quotas) and security vulnerabilities. Additionally, the scanned image cannot be imported directly into a workflow or application on the client device.

A third approach is scan-to-FTP (File Transfer Protocol). In scan-to-FTP, the user inputs into a scanner device or selects on the scanner device a pre-stored file path or associated workflow and the scanner device scans the image and routes the scanned image to a client device on which the file resides. Where a destination workflow is identified, the workflow may be automatically initiated when the scanned image arrives at the client device. A shortcoming of this approach is that the user must know the file path or workflow at the time the image is scanned. Moreover, the user may input or select an erroneous file path or workflow and not realize the error until after he or she has returned to the client device. Furthermore, there must be network connectivity between the scanner device and the client device. Additionally, the scanned image cannot be imported directly into an application on the client device.

A fourth approach is to support scanning as a standardized web service. In a web service approach, a scan web service client on the client device discovers scanner devices that expose a scan web service and control one of the discovered scanner devices to scan an image and download the scanned image to the client device. In some cases, the scanned image can be imported directly into an application on the client device. A shortcoming of this approach is that the user typically must make two trips to the scanner device—one to place a hardcopy on the platen glass or automatic document feeder (ADF) of the scanner device before scanning and a second time to retrieve the hardcopy from the glass platen or ADF after initiating a scan request from the client device. The user may also have difficulty determining which physical scanner devices correspond with scanner devices identified on the client device, and which scans performed on a given physical scanner device correspond to which scan requests.

### SUMMARY OF THE INVENTION

The present invention, in a basic feature, provides a method and system for follow-me scanning in a shared resource environment. The present invention improves image scanning in a shared resource environment in part by decoupling the act of generating a scanned image from the act of identifying a destination for the scanned image. In accordance with the teachings of the invention, a user scans an image on a shared scanner device without identifying a destination for the scanned image. When the user later wants to use the scanned image, the user specifies a destination for the scanned image and the scanned image is sent to the destination. A user can thus, without giving any consideration to a destination for a scanned image, generate the scanned image on an arbitrary scanner device and, at a later time, recover the scanned image using an arbitrary client device. In some embodiments, follow-me scanning is facilitated by a server device that intermediates between an arbitrary number of scanner devices and an arbitrary number of client devices and allows the scanned image to be imported directly into workflows and applications running on the client devices.

In one aspect of the invention, a server device comprises one or more network interfaces and a processor communicatively coupled with the network interfaces, wherein the server device receives from a scanner device via one of the network interfaces a scanned image and a scan job identifier and under control of the processor stores in a storage element the scanned image in association with the scan job identifier, and wherein in response to a request having the scan job identifier received from a client device via one of the network interfaces and under control of the processor the server device retrieves from the storage element using the scan job identifier the scanned image and transmits the scanned image to the client device.

In some embodiments, the scan job identifier stored on the storage element and the scan job identifier in the request are generated on the scanner device and the client device, respectively, from scan job identifiers input by a common user on the scanner device and the client device, respectively.

In some embodiments, the scan job identifier stored on the storage element and the scan job identifier in the request are encrypted on the scanner device and the client device, respectively.

In some embodiments, the server device receives from the scanner device via one of the network interfaces a conflict check request regarding the scan job identifier.

In some embodiments, the request has delivery options selected by a user of the client device and under control of the processor the server device applies the selected delivery options to the scanned image retrieved from the storage element.

In some embodiments, the scanned image retrieved from the storage element is directly imported into a workflow executing on the client device.

In some embodiments, the scanned image retrieved from the storage element is directly imported into an application executing on the client device.

In another aspect of the invention, a client device comprises a user interface, a network interface and a processor communicatively coupled with the user interface and the network interface, wherein under control of the processor the client device transmits to a server device via the network interface a request having a scan job identifier generated from a scan job identifier input in a first instance on a scanner device in association with generation of a scanned image and input in a second instance on the user interface in association with generation of the request, and in response to the request receives from the server device via the network interface the scanned image.

In some embodiments, the scan job identifier in the request is an encrypted scan job identifier and the scan job identifier input in the first and second instances is a plaintext scan job identifier.

In some embodiments, under control of the processor the client device discovers the server device in a discovery process conducted via the network interface.

In some embodiments, under control of the processor the client device discovers delivery options supported on the server device in a discovery process conducted via the network interface.

In some embodiments, the request is generated under control of the processor in response to input into a request form displayed on the user interface.

In some embodiments, the request form has a scan job identifier entry field and selectable delivery options discovered from the server device.

In yet another aspect of the invention, a method for follow-me scanning in a shared resource environment comprises the steps of receiving from a scanner device a scanned image and a scan job identifier, storing in a storage element the scanned image in association with the scan job identifier, receiving from a client device a request having the scan job identifier, retrieving from the storage element using the scan job identifier the scanned image and transmitting the scanned image to the client device.

In some embodiments, the scan job identifier stored on the storage element and the scan job identifier in the request are generated on the scanner device and the client device, respectively, from scan job identifiers input by a common user on the scanner device and the client device, respectively.

In some embodiments, the scan job identifier stored on the storage element and the scan job identifier in the request are encrypted on the scanner device and the client device, respectively.

In some embodiments, the method further comprises the step of receiving from the scanner device a conflict check request regarding the scan job identifier.

In some embodiments, the scan job identifier stored on the storage element and the scan job identifier in the request are hash values.

In some embodiments, the scanned image retrieved from the storage element is directly imported into a workflow executing on the client device.

In some embodiments, the scanned image retrieved from the storage element is directly imported into an application executing on the client device.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a communication system in which the present invention is operative in some embodiments.

FIG. 2 shows a representative scanner device in the communication system of FIG. 1.

FIG. 3 shows software elements of the representative scanner device of FIG. 2.

FIG. 4 shows a representative client device in the communication system of FIG. 1.

FIG. 5 shows software elements of the representative client device of FIG. 4.

FIG. 6 shows the server device in the communication system of FIG. 1.

FIG. 7 shows software elements of the server device of FIG. 6.

FIG. 8 shows steps of a follow-me scanning method performed on a scanner device in some embodiments of the invention.

FIG. 9 shows steps of a follow-me scanning method performed on a client device in some embodiments of the invention.

FIG. 10 shows steps of a follow-me scanning method performed on a server device in some embodiments of the invention.

### DETAILED DESCRIPTION OF A PREFERRED EMBODIMENT

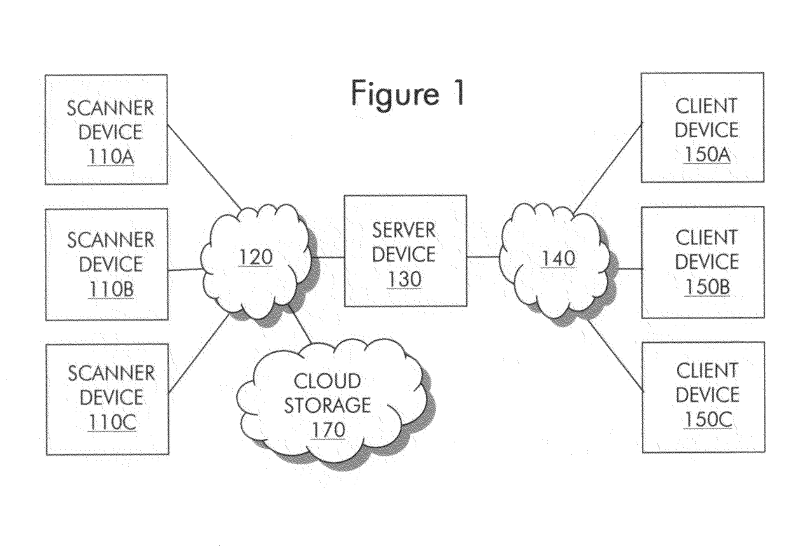

FIG. 1 shows a communication system in which the present invention is operative in some embodiments. The communication system includes multiple scanner devices 110A, 110B, 110C communicatively coupled with a server device 130 via a first communication network 120, and multiple client devices 150A, 150B, 150C communicatively coupled with server device 130 via a second communication network 140. Server device 130 is also communicatively coupled with cloud storage 170 via first communication network 120. Scanner devices 110A, 110B, 110C and client devices 150A, 150B, 150C do not communicate directly. Instead, server device 130 projects to client devices 150A, 150B, 150C a virtual scanner service that enables client devices 150A, 150B, 150C to acquire and import directly into workflows and applications scanned images generated on scanner devices 110A, 110B, 110C. While three each of scanner devices 110A, 110B, 110C and client devices 150A, 150B, 150C are shown by way of example, in other embodiments of the invention the number of scanner devices and client devices may differ.

Communication network 120 is a secure data communication network. In some embodiments, network 120 consists of dedicated physical connections between scanner devices 110A, 110B, 110C and server device 130 and between server device 130 and cloud storage 170, such as SCSI, USB and/or parallel port connections. In other embodiments, network 120 is a wired or wireless network that includes an arbitrary number of multiplexing nodes, such as Institute of Electrical and Electronics Engineers (IEEE) 803.2 (wired Ethernet) switches and 802.11 (Wi-Fi) or 802.16 (WiMax) access points, and/or Internet Protocol (IP) routers, that execute data communication protocols to store and forward data traffic between scanner devices 110A, 110B, 110C, server device 130 and cloud storage 170. In other embodiments, network 120 is an optical network in which fiber optics or other optical technologies utilize a waveguide to guide an optical beam between two arbitrary points. Communication between scanner devices 110A, 110B, 110C and server device 130 may be realized using a web services for devices (WSD) scan web service protocol, or an alternative scanning protocol such as TWAIN (Technology Without Any Impressive Name), SANE (Scanner Access Now Easy) or ISIS (Image and Scanner Interface Specification), with network security provided at least in part by a firewall.

Communication network 140 is a wired or wireless data communication network that includes an arbitrary number of multiplexing nodes, such as Ethernet switches, WiMAX and/or Wi-Fi access points, IP routers and/or cellular communication nodes, that execute data communication protocols to store and forward data traffic between client devices 150A, 150B, 150C and server device 130. Communication between client devices 150A, 150B, 150C and server device 130 may be realized using a WSD scan web service protocol, or an alternative network scanning protocol such as Windows Image Acquisition (VIA), TWAIN, SANE or ISIS.

Cloud storage 170 includes an arbitrary number of storage elements for temporarily storing scan job records that include scanned images and associated encrypted scan job identifiers. In some embodiments, the storage elements include file server devices. In some embodiments, cloud storage 170 also includes a location server for facilitating retrieval of stored scan job records. While cloud storage 170 is shown in FIG. 1 as an independent network-attached element, cloud storage 170 may in some embodiments of the invention reside in whole or in part on one or more of scanner devices 110A, 110B, 110C or server device 130.

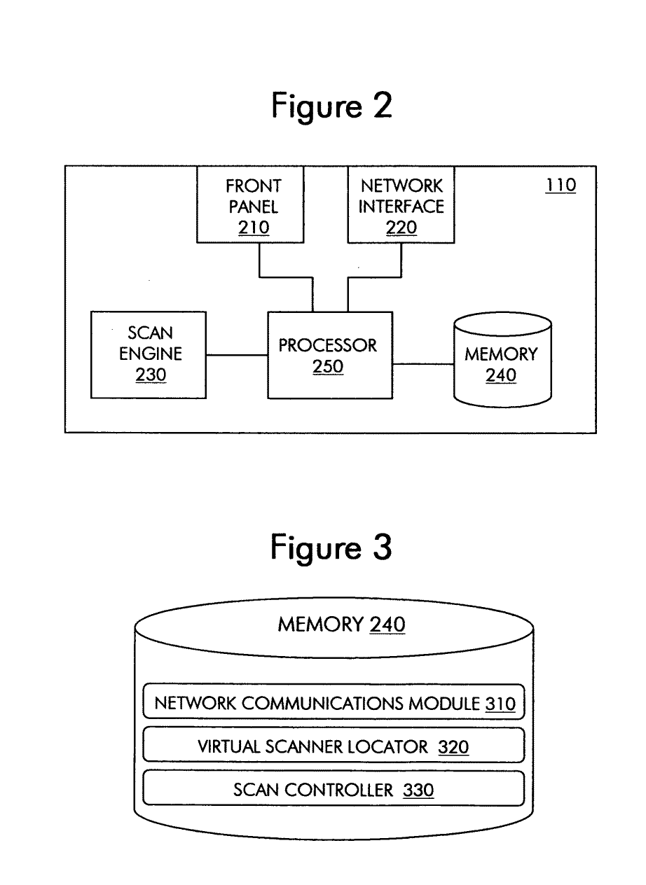

Scanner devices 110A, 110B, 110C may be dedicated to scanning or may support additional imaging functions, such as printing, copying, faxing and filing. Turning to FIG. 2, a representative scanner device 110 is shown to have a front panel 210. Front panel 210 has an input mechanism, such as a keyboard, keypad or touch screen for accepting inputs from walk-up users and an output mechanism, such as a liquid crystal display (LCD) or light emitting diode (LED) display, for displaying outputs to walk-up users. Scanner device 110 also has a network interface 220 that communicatively couples scanner device 110 with communication network 120. Network interface 220 may be a SCSI interface, a USB port, a parallel port, or a wired or wireless data communication interface, such as wired Ethernet or Wi-Fi interface. Internal to scanner device 110, front panel 210 and network interface 220 are communicatively coupled with a processor 250, which is also communicatively coupled with a scan engine 230 and a memory 240. Scan engine 230 includes scanner logic and a mechanical section for performing scanning functions. For example, scan engine 230 may have a line image sensor mounted on a movable carriage for optically scanning a hardcopy (e.g. document) placed on a glass platen under the control of scanner logic, after which the scanned image generated from the hardcopy is stored in memory 240 under control of processor 250. Memory 240 includes one or more random access memory (RAM) elements and one or more read-only memory (ROM) elements. Processor 250 executes software installed in memory 240 to carry-out operations on scanner device 110, including uploading to server device 130 in a discovery process the identity, scan capabilities and scan options of scanner device 110, servicing scan job requests initiated on front panel 210 by walk-up users, encrypting plain text scan job identifiers input on front panel 210 by walk-up users in connection with scan job requests and uploading to server device 130 scan job records including scanned images and associated encrypted scan job identifiers for storage by server device 130 in cloud storage 170.

FIG. 3 shows software elements of representative scanner device 110 to include a network communications module 310, a virtual scanner locator 320 and a scan controller 320. Network communications module 310 manages connectivity with other devices, including server device 130, via network interface 220. Scanner device 110 uses this connectivity to interact with a virtual scanner service running on server device 130 and exchange information with the virtual scanner service, including scanned images uploaded for storage by the virtual scanner service in cloud storage 170.

Virtual scanner locator 320 locates a virtual scanner service running on server device 130 and uploads to server device 130 scan capabilities and options supported on scanner device 110. In some embodiments, virtual scanner locator 320 executes a discovery protocol, such as Windows Vista WSD device discovery, to dynamically discover the virtual scanner service. In other embodiments, virtual scanner locator 320 has access to addressing information for server device 130 configured on client device 150 by a manufacturer, administrator or user that is sufficient to enable scanner device 110 to contact the virtual scanner service and upload scan capabilities and options supported by scanner device 110.

Scan controller 330 displays on front panel 210 a scan job request form that presents scan options supported by scanner device 110 as selectable options along with a scan job identifier entry field. When a walk-up user completes the request form, scan controller 330 enables scan engine 230 to scan a hardcopy placed by the user on the glass platen or ADF of scanner device 110 to generate a scanned image conformant with user-selected scan options. Scan controller 330 encrypts a plaintext scan job identifier entered by the walk-up user using a one-way hash algorithm, such as Message Digest Five (MD5), to produce an encrypted scan job identifier. Once the scanned image has been generated, scan controller 330 creates a scan job record including the scanned image and the encrypted scan job identifier and, using addressing information for server device 130 acquired from virtual scanner locator 320, transmits the scan job record to server device 130 via network interface 220. In response to the request, server device 130 returns an acknowledgement to scanner device 110.

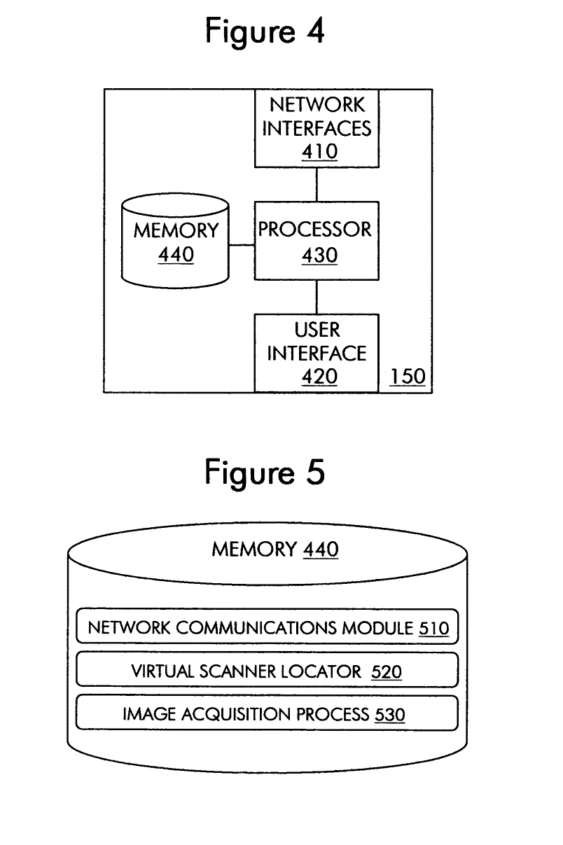

FIG. 4 shows a representative client device 150 in the communication system of FIG. 1. Client device 150 may be a desktop personal computer, a mobile personal computer, a personal data assistant (PDA) or a mobile phone, for example. Client device 150 includes a network interface 410, a user interface 420 and a memory 440, all of which are communicatively coupled with a processor 430. Network interface 410 is a wired or wireless communications interface, such as Ethernet, cellular, WiMax, or Wi-Fi interface, that communicatively couples client device 150 to communication network 140. User interface 420 has an input mechanism, such as a keyboard, keypad or touch screen for accepting inputs from a user and an output mechanism, such as a LCD display, LED display, or cathode ray tube (CRT) for displaying outputs to a user. Memory 440 includes one or more RAM and one or more ROM elements. Processor 430 executes software installed in memory 440 to carry-out operations on client device 150 including discovering server device 130 and scan delivery options supported thereon, generating and transmitting scan job requests in response to inputs on user interface 420 and outputting on user interface 420 scanned images retrieved in response scan job requests in accordance with delivery options selected by a user.

FIG. 5 shows software elements of representative client device 150 to include a network communications module 510, a virtual scanner locator 520 and an image acquisition process 530. Network communications module 510 manages connectivity between client device 150 and other devices, such as server device 130, via network interface 410. Client device 150 uses this connectivity to interact with a virtual scanner service running on server device 130 for downloading scanned images stored in cloud storage 170 pursuant to earlier user activity on scanner devices 110A, 110B, 11C.

Virtual scanner locator 520 locates a virtual scanner service running on server device 130. In some embodiments, virtual scanner locator 520 executes a discovery protocol, such as Windows Vista WSD device discovery, to dynamically discover the virtual scanner service and capabilities and delivery options supported by the virtual scanner service. In other embodiments, virtual scanner locator 520 has access to addressing information for server device 130 configured on client device 150 by a manufacturer, administrator or user sufficient to enable client device 150 to contact the virtual scanner service and download capabilities and delivery options supported by the virtual scanner service.

Image acquisition process 530 interacts with a user of client device 150 and a virtual scanner service executing on server device 130 to acquire and display scanned images. The user of client device 150 is a previous walk-up user of one of scanner devices 110A, 110B, 110C who now wishes to retrieve an earlier generated and stored scanned image. Process 530 may be a workflow, application or scan driver that is capable of executing scan jobs in a conventional environment wherein process 530 interacts directly with a physical scanner device in the absence of any virtual scanner service. In the present environment, a virtual scanner service on server device 130 emulates this conventional environment by appearing to process 530 as a physical scanner device located by client device 150 that generates scanned images in real-time in response to scan job requests initiated by process 530. However, in the present environment, the virtual scanner service in fact, in response to scan job requests initiated by process 530, retrieves from cloud storage 170 pre-stored scanned images generated at an earlier time on a plurality of scanner devices 110A, 110B, 110C that are represented by the virtual scanner service.

More particularly, when a scan job request is initiated within process 530, process 530 acquires from virtual scanner locator 520 known addressing information, capabilities and delivery options associated with the virtual scanner service. Process 530 uses the capabilities and delivery options to create and render on user interface 420 a scan job request form that presents the delivery options supported by the virtual scanner service as selectable options along with a scan job identifier entry field. Once the request form is completed by a user, process 530 generates a scan job request based on information in the completed request form. In particular, process 530 extracts a plaintext scan job identifier entered by a user in the scan job identifier entry field of the request form and encrypts the plaintext scan job identifier using a one-way hash algorithm, such as MD5, to produce an encrypted scan job identifier. Process 530 also extracts delivery options selected by the user from among the selectable options in the request form. Process 530 then generates a scan job request including the encrypted scan job identifier and the selected delivery options and transmits the request to server device 130 via network interface 410. In response to the request, server device 130 returns a scanned image in conformance with the selected delivery options that is imported directly into process 530 and displayed on user interface 420. Application by the virtual scanner service of the encrypted scan job identifier to retrieve the scanned image from cloud storage 170 is not visible to process 530; from the perspective of process 530 the virtual scanner device appears to be a conventional physical scanner device located by client device 150 that generates scanned images in real-time in response to scan job requests.

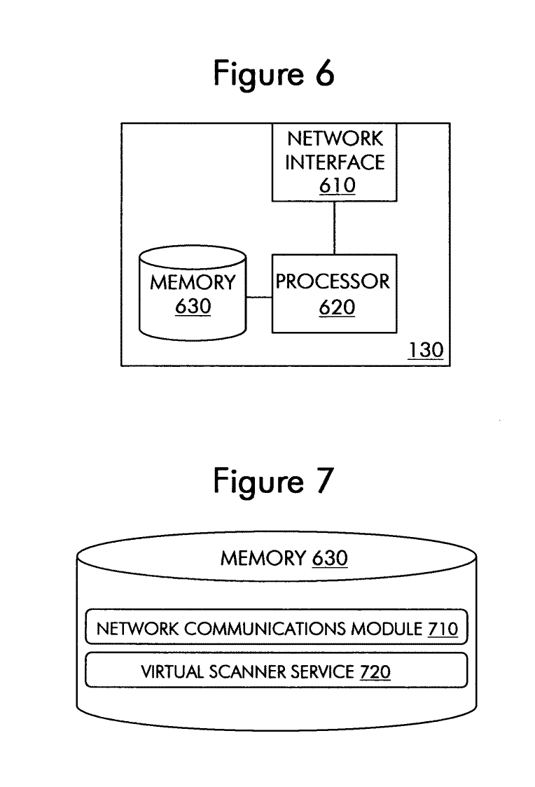

FIG. 6 shows server device 130 in more detail to include network interfaces 610 and a memory 630 communicatively coupled with a processor 620. Network interfaces 610 include one or more wired or wireless communications interfaces, such as Ethernet or Wi-Fi interfaces and may additionally include SCSI interfaces, USB ports, parallel ports, that communicatively couple server device 130 to communication networks 120, 140. Memory 630 includes one or more RAM and one or more ROM elements. Processor 620 executes software installed in memory 630 to carry-out operations on server device 130 including uploading scanner identities and scan capabilities and options from scanner devices 110A, 110B, 110C in a discovery process, downloading virtual scanner service capabilities and delivery options to client devices 150A, 150B, 150C in a discovery process, storing scanned images in cloud storage 170 in response to scan job records received from scanner devices 110A, 110B, 110C, retrieving scanned images from cloud storage 170 in response to scan job requests received from client devices 150A, 150B, 150C and generating and transmitting scan job responses including scanned images in response to scan job requests received from client devices 150A, 150B, 150C.

FIG. 7 shows software elements of server device 130 to include a network communications module 710 and a virtual scanner service 720. Network communications module 710 manages connectivity with other devices, such as with scanner devices 110A, 110B, 110C and client devices 150A, 150B, 150C, via network interfaces 610. Server device 130 uses this connectivity to interact with scanner devices 110A, 110B, 110C, storage elements in cloud storage 170 and virtual scanner locators and image acquisition processes executing on client devices 150A, 150B, 150C, respectively.

Virtual scanner service 720 interacts with scanner devices 110A, 110B, 110C and virtual scanner locators and image acquisition processes running on client devices 150A, 150B, 150C, respectively, to enable follow-me scanning. In some embodiments, virtual scanner service 720 executes a discovery protocol, such as Windows Vista WSD device discovery, to dynamically discover identities, scan options and capabilities of scanner devices 110A, 110B, 110C and advertise its own identity, capabilities and delivery options to client devices 150A, 150B, 150C. In other embodiments, addressing information for server device 130 configured on scanner devices 110A, 110B, 110C and client devices 150A, 150B, 150C is used to contact server device 130 and upload/download capabilities and options. Capabilities and delivery options downloaded by virtual scanner service 720 to client devices 150A, 150B, 150C may include capabilities and scan options advertised by scanner devices 110A, 110B, 110C as well as enhanced capabilities and options supported by virtual scanner service 720.

Virtual scanner service 720 receives from scanner devices 110A, 110B, 110C scan job records including scanned images and associated encrypted scan job identifiers and stores the scan job records in cloud storage 170. In response to a received scan job record, virtual scanner service 720 stores the scanned image from the record in association with the encrypted scan job identifier from the record at an available location in cloud storage 170. The encrypted scan job identifier provides a lookup key that can be used by virtual scanner service 720 at a later time to retrieve the scanned image. Once the scanned image is stored, virtual scanner service 720 downloads to the one of scanner devices 110A, 110B, 110C from which the scan job record was received a scan job record acknowledgement.

Virtual scanner service 720 receives from client devices 150A, 150B, 150C scan job requests including encrypted scan job identifiers and selected delivery options. In response to a scan job request, virtual scanner service 720 retrieves a scanned image from an available location in cloud storage 170 using the encrypted scan job identifier from the request as a lookup key. In some embodiments, cloud storage 170 includes multiple physical storage devices and has a location server that virtual scanner service 720 can query to resolve an encrypted scan job identifier to a Uniform Resource Identifier (URI) of the physical storage device on which a scanned image is stored, which URI is then applied by virtual scanner service 720 to retrieve the scanned image from the identified physical storage device. Once the scanned image is retrieved, virtual scanner service 720 downloads to the requesting one of client devices 150A, 150B, 150C a scan job response including the scanned image in conformance with the requested delivery options.

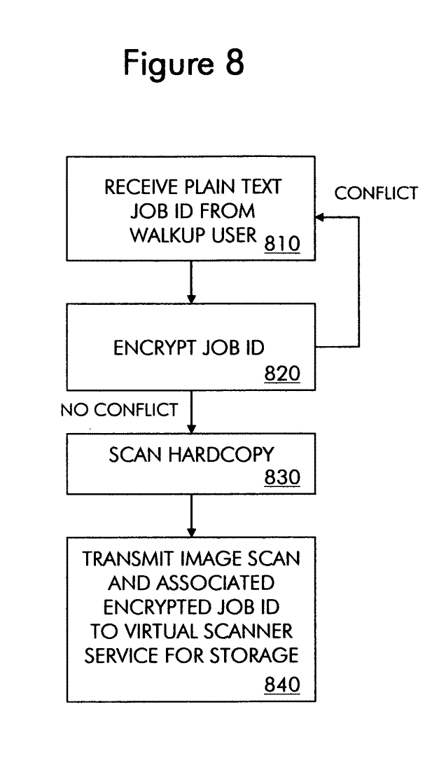

FIG. 8 shows steps of a follow-me scanning method performed on scanner device 110 in some embodiments of the invention. After a discovery process between scanner device 110 and server device 130, a walk-up user approaches scanner device 110. The walk-up user does not authenticate or input any scan destination information. The walk-up user inputs a plaintext scan job identifier on front panel 210 of scanner device 110 (810). Scan controller 320 encrypts the plaintext scan job identifier (820) and transmits a conflict check request to server device 130 asking virtual scanner service 720 to verify that the encrypted job identifier does not conflict with an already in use encrypted job identifier, i.e. to verify that the encrypted job identifier is unique. If there is a conflict, scan controller 320 notifies the walk-up user of the conflict via a message on front panel 210 and requires the walk-up user to input a different plaintext scan job identifier on front panel 210 (810), and the conflict check is repeated until there is no conflict or the walk-up user terminates the process. If there is no conflict, scan controller 320 enables scan engine 330 to scan the hardcopy placed on the glass platen or ADF by the walk-up user (830) and transmits to virtual scanner service 720 a scan job record including the scanned image and the associated encrypted scan job identifier (840), in response to which a scan job record acknowledgement is returned from server device 130.

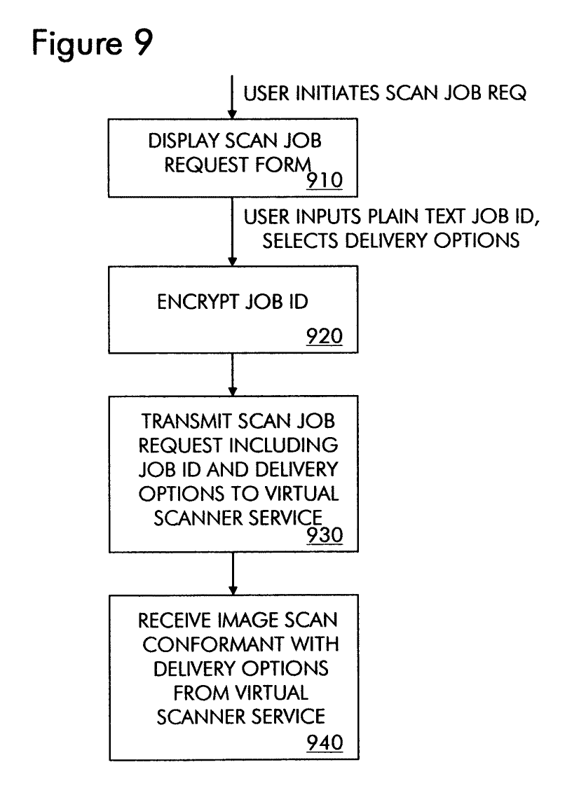

FIG. 9 shows steps of a follow-me scanning method performed on client device 150 in some embodiments of the invention. These steps are performed after the steps described in FIG. 8 at a time when the aforementioned walk-up user wishes to retrieve and use the pre-stored scanned image, and after a discovery process between client device 150 and server device 130. The aforementioned walk-up user initiates a scan job request (910) in response to which image acquisition process 530 renders on user interface 420 a scan job request form (910). The scan job request may be initiated within an active workflow or application, or by opening a scan driver, for example. The user completes the scan job request form including specification of the same plaintext scan job identifier that was previously input by the user on scanner device 110 and selected delivery options. Image acquisition process 530 encrypts the plaintext scan job identifier (920) and transmits to virtual scanner service 720 a job scan request including the encrypted scan job identifier and selected delivery options (930). Client device 150 receives from virtual scanner service 720 in response to the request a scanned image in conformance with the selected delivery options, which is directly imported into the image acquisition process 530 and rendered on user interface 420 (940).

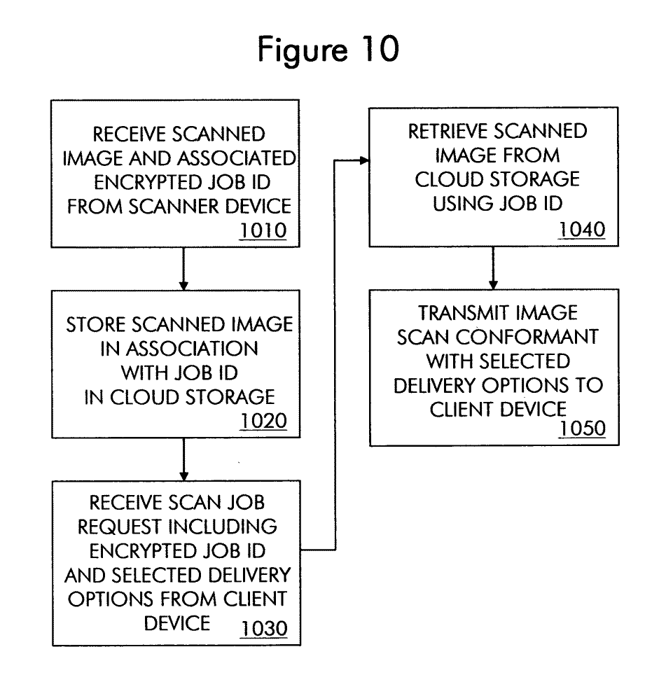

FIG. 10 shows steps of a follow-me scanning method performed on server device 130 in some embodiments of the invention. After a discovery process between scanner device 110 and server device 130, server device 130 receives from scanner device 110 a scan job record including a scanned image and an associated encrypted scan job identifier (1010). Virtual scanner service 720 stores the scan job record in at an available location in cloud storage 170 (1020) in a manner that enables the scan job record to be indexed using the encrypted scan job identifier, and transmits an acknowledgement to scanner device 110. At a later time, and after a discovery process between client device 150 and server device 130, server device 130 receives from client device 150 a scan job request including the encrypted scan job identifier and delivery options (1030). Virtual scanner service 720 retrieves the scan job record from cloud storage 170 using the encrypted scan job identifier (1040) and transmits to client device 150 a scan job response including the scanned image in conformance with the selected delivery options (1050).

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A server device, comprising:
one or more network interfaces; and
a processor communicatively coupled with the network interfaces, wherein the server device receives from a scanner device via one of the network interfaces a scanned image and a scan job identifier and under control of the processor stores in a storage element the scanned image in association with the scan job identifier, and wherein in response to a request having the scan job identifier received from a client device via one of the network interfaces and under control of the processor the server device retrieves from the storage element using the scan job identifier the scanned image and transmits the scanned image to the client device.

2. The server device of claim 1, wherein the scan job identifier stored on the storage element and the scan job identifier in the request are generated on the scanner device and the client device, respectively, from scan job identifiers input by a common user on the scanner device and the client device, respectively.

3. The server device of claim 1, wherein the scan job identifier stored on the storage element and the scan job identifier in the request are encrypted on the scanner device and the client device, respectively.

4. The server device of claim 1, wherein the server device receives from the scanner device via one of the network interfaces a conflict check request regarding the scan job identifier.

5. The scanner device of claim 1, wherein the request has delivery options selected by a user of the client device and under control of the processor the server device applies the selected delivery options to the scanned image retrieved from the storage element.

6. The server device of claim 1, wherein the scanned image retrieved from the storage element is directly imported into a workflow executing on the client device.

7. The server device of claim 1, wherein the scanned image retrieved from the storage element is directly imported into an application executing on the client device.

8. A client device, comprising:
a user interface;
a network interface; and
a processor communicatively coupled with the user interface and the network interface, wherein under control of the processor the client device transmits to a server device via the network interface a request having a scan job identifier generated from a scan job identifier input in a first instance on a scanner device in association with generation of a scanned image and input in a second instance on the user interface in association with generation of the request, and in response to the request receives from the server device via the network interface the scanned image.

9. The client device of claim 8, wherein the scan job identifier in the request is an encrypted scan job identifier and the scan job identifier input in the first and second instances is a plaintext scan job identifier.

10. The client device of claim 8, wherein under control of the processor the client device discovers the server device in a discovery process conducted via the network interface.

11. The client device of claim 8, wherein under control of the processor the client device discovers delivery options supported on the server device in a discovery process conducted via the network interface.

12. The client device of claim 8, wherein the request is generated under control of the processor in response to input into a request form displayed on the user interface.

13. The client device of claim 12, wherein the request form has a scan job identifier entry field and selectable delivery options discovered from the server device.

14. A method for follow-me scanning in a shared resource environment, comprising the steps of:
receiving from a scanner device a scanned image and a scan job identifier;
storing in a storage element the scanned image in association with the scan job identifier;
receiving from a client device a request having the scan job identifier;
retrieving from the storage element using the scan job identifier the scanned image; and
transmitting the scanned image to the client device.

15. The method of claim 14, wherein the scan job identifier stored on the storage element and the scan job identifier in the request are generated on the scanner device and the client device, respectively, from scan job identifiers input by a common user on the scanner device and the client device, respectively.

16. The method of claim 14, wherein the scan job identifier stored on the storage element and the scan job identifier in the request are encrypted on the scanner device and the client device, respectively.

17. The method of claim 14, further comprising the step of receiving from the scanner device a conflict check request regarding the scan job identifier.

18. The method of claim 14, wherein the scan job identifier stored on the storage element and the scan job identifier in the request are hash values.

19. The method of claim 14, wherein the scanned image retrieved from the storage element is directly imported into a workflow executing on the client device.

20. The method of claim 14, wherein the scanned image retrieved from the storage element is directly imported into an application executing on the client device.
